(19) United States
(12) Patent Application Publication
(10) Pub. No.: US 2014/0017021 A1
(43) Pub. Date: Jan. 16, 2014

(54) APPARATUS FOR REMOVING RETAINER MATERIAL

(71) Applicants: Mark Carmine Bellino, Greenville, SC (US); Charles Van Buchan, Greer, SC (US); Heath Michael Ostebee, Piedmont, SC (US)

(72) Inventors: Mark Carmine Bellino, Greenville, SC (US); Charles Van Buchan, Greer, SC (US); Heath Michael Ostebee, Piedmont, SC (US)

(73) Assignee: General Electric Company, Schenectady, NY (US)

(21) Appl. No.: 13/547,693

(22) Filed: Jul. 12, 2012

(51) Int. Cl. B23C 5/02

(52) U.S. Cl. 408/203.5

(57) ABSTRACT

An apparatus for removing retaining material proximate to a fastener on a surface is disclosed. The apparatus has a cavity dimensioned for receiving at least a portion of the fastener and has a non-abrasive face at its distal end. The apparatus also has a plurality of cutting inserts that are disposed proximate to the non-abrasive face and that each extend at least partially beyond the non-abrasive face while at least a portion of the non-abrasive face remains exposed to the surface. The cutting inserts are configured to rotate around the fastener to remove the retaining material.

### BACKGROUND OF THE INVENTION

The subject matter disclosed herein relates to an apparatus for removing retainer material proximate to a fastener on a surface.

Fasteners, including hexagonal and round head fasteners, are used to penetrate through and retain surfaces (e.g., sheet metal). The fasteners are often held in place on the surfaces by retainer material, such as by tack welds or braze located proximate to the head of the fastener. Removal of the retainer material typically involves using a hand held grinding tool having a rotating shaft and a carbide tip. The use of this type of grinding tool can cause damage to the fastener itself or cause damage to the surface. Because fasteners are often located in confined spaces, the rotating shaft and carbide tip of this grinding tool can also cause damage to other objects located proximate to the fastener.

The discussion above is merely provided for general background information and is not intended to be used as an aid in determining the scope of the claimed subject matter.

### BRIEF DESCRIPTION OF THE INVENTION

An apparatus for removing retaining material proximate to a fastener on a surface is disclosed. The apparatus has a cavity dimensioned for receiving at least a portion of the fastener and has a non-abrasive face at its distal end. The apparatus also has a plurality of cutting inserts that are disposed proximate to the non-abrasive face and that each extend at least partially beyond the non-abrasive face while at least a portion of the non-abrasive face remains exposed to the surface. The cutting inserts are configured to rotate around the fastener to remove the retaining material. An advantage that may be realized in the practice of some disclosed embodiments of the apparatus is the reduction in damage to the surface or the fastener when removing the fastener and retaining material.

In one embodiment, an apparatus for removing retainer material proximate to a fastener on a surface is disclosed. The apparatus comprises a body comprising a first side and a second side, a wall extending away from the second side of the body in a first direction, the wall comprising an inner surface, a proximal end, a distal end, and a non-abrasive face at the distal end, a cavity formed by the second side of the body and the inner surface of the wall, and comprising a center axis extending through the cavity and substantially parallel to the first direction, and a plurality of cutting inserts disposed proximate to the non-abrasive face and extending in the first direction at least partially beyond the non-abrasive face and wherein at least a portion of the non-abrasive face remains exposed to the surface.

In another embodiment, the apparatus comprises a body comprising a first side and a second side, a wall extending away from the second side of the body in a first direction, the wall comprising an inner surface, a proximal end, a distal end, and a non-abrasive face at the distal end, a cavity formed by the second side of the body and the inner surface of the wall, and comprising a center axis extending through the cavity and substantially parallel to the first direction, a shaft attached to the first side of the body and oriented co-axial with the center axis, and a plurality of cutting inserts disposed proximate to the non-abrasive face and extending in the first direction at least partially beyond the non-abrasive face and wherein at least a portion of the non-abrasive face remains exposed to the surface.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 illustrates a side cross-sectional view of an exemplary embodiment of a tool placed over a fastener for removing retaining material proximate to the fastener on a surface;

FIG. 2 illustrates a view of the face of the tool of FIG. 1;

FIG. 3 illustrates a side cross-sectional view of a cutting insert that extends in the first direction partially beyond the non-abrasive face and that does not extend beyond the inner surface of the wall of the tool;

FIG. 4 illustrates a side cross-sectional view of a cutting insert that extends in the first direction partially beyond the non-abrasive face and that extends toward the center axis entirely beyond the inner surface of the wall of the tool;

FIG. 5 illustrates a side cross-sectional view of a cutting insert that extends in the first direction entirely beyond the non-abrasive face and that does not extend beyond the inner surface of the wall of the tool; and

FIG. 6 illustrates a side cross-sectional view of a cutting insert that extends in the first direction entirely beyond the non-abrasive face and that extends toward the center axis partially beyond the inner surface of the wall of the tool.

### DETAILED DESCRIPTION OF THE INVENTION

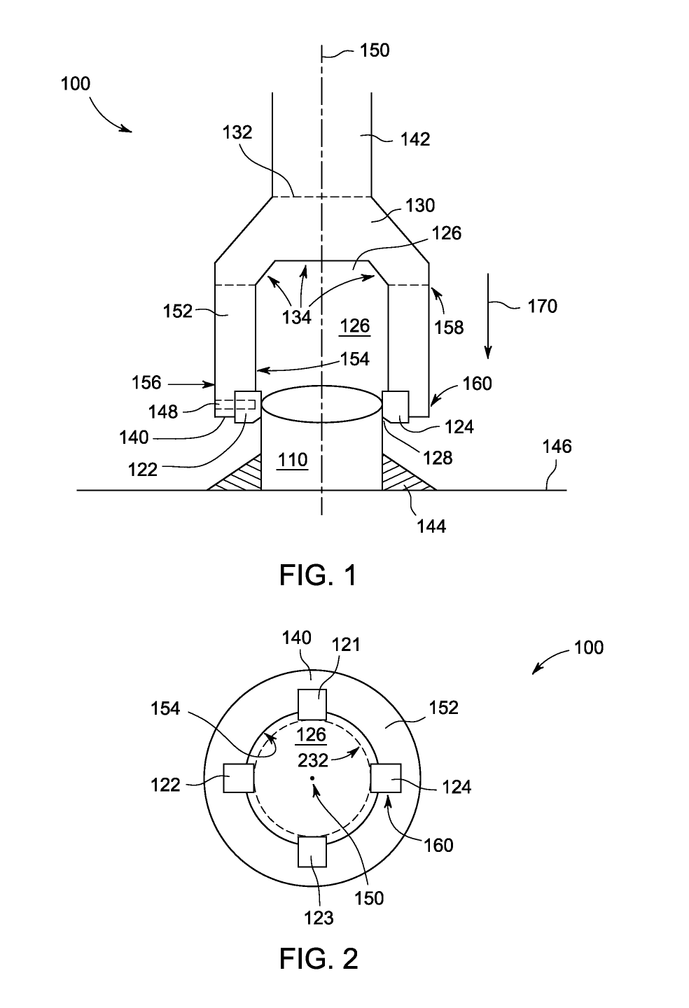

FIG. 1 illustrates a side cross-sectional view of an exemplary embodiment of an apparatus or tool 100 placed over a fastener 110 for removing retaining material 114 proximate to the fastener 110 on a surface 146. FIG. 2 illustrates a view of the non-abrasive face 140 of the tool 100 of FIG. 1. Upon cutting away a substantial portion of the retaining material 144, the fastener 110 can be more easily extracted from the surface 146.

The tool 100 comprises a body 130 having a first side 132 and a second side 134. A shaft 142 extends away from the first side 132 of the body 140 and is used to rotate the tool 100. A wall 152 extends in a first direction 170 away from the second side 134 of the body 130. The wall 152 comprises an inner surface 154, an outer surface 156, a proximal end 158 that is adjacent to the second side 134 of the body 130, and a distal end 160 having non-abrasive face 140 (e.g., substantially smooth face that will not cut through the surface 146). In one embodiment, the wall 152 forms a cylinder surrounding a cavity 126 formed between the second side 134 of the body 130 and the inner surface 154 of the wall 152. While the exemplary fastener 110 is a round head fastener, the cavity 126 and inner surface 154 of the wall 152 can be dimensioned to surround and receive the fastener 110 whether it has a hexagonal or round profile. A center axis 150 extends through the cavity 126 and through the tool 100 in a direction that is substantially parallel to the first direction 170.

A plurality of cutting inserts 121-124 (first cutting insert 121, second cutting insert 122, third cutting insert 123, and fourth cutting insert 124) are disposed proximate to the non-abrasive face 140 on the distal end 160 of the wall 152. The cutting inserts 121-124 can be made of carbide steel, high speed steel, diamond, or other suitable materials and, in some embodiments, can be replaced when worn. As shown in FIG. 1, a threaded bolt 148 extends through the wall 152 and is received by the cutting insert 121-124 to attach to the wall 152. In one embodiment, the threaded bolt 148 is rotated using an Allen wrench.

As shown in FIG. 2, the cutting inserts 121-124 are located along a circumferential cutting path 232 inside of the cavity 126 that surrounds and is equidistant from the center axis 150. This circumferential cutting path 232 defines a plane that is substantially perpendicular to the center axis 150 and that is substantially parallel to the surface 146. Rotation of the shaft 142, which extends in a direction coaxial with the first center axis 150, causes the body 130 and the cutting inserts 121-124 to rotate along the circumferential path 232 to cut away the retaining material 144. In some embodiments, the shaft 142 is attached to a hand held drilling device. In other embodiments, the shaft 142 is attached to a milling machine.

In operation, the tool 100 is placed over the head of the fastener 110 and then rotated around the fastener 110 to remove the retaining material 114. Each cutting insert 121-124 can have a chamfer 128 to facilitate placing the tool 100 over the head of the fastener 110. While moving along the circumferential cutting path 232, the cutting inserts 121-124 cut through retaining material 144. The tool 110 is gradually lowered around the fastener 110 toward the surface 146 to cut through the remaining retaining material 144.

At least a portion of each cutting insert 121-124 extends in the first direction 170 beyond the non-abrasive face 140 while at least a portion of the non-abrasive face 140 remains exposed to the surface 146. The non-abrasive face 140 is designed to prevent the cutting inserts 121-124 from substantially cutting into or through the surface 146 when the non-abrasive face 140 comes into contact with the surface 146, at which point the tool 100 is said to have an “interrupted cut” or to have “bottomed out”. In this way, the non-abrasive face 140 limits the penetration of the cutting inserts 121-124 to no more than scratching the surface 146 while removing retaining material 144. In one embodiment, the length of the portion of the cutting inserts 121-124 that extends beyond the non-abrasive face is at least 0.005 in. (0.127 mm). This tool 100 will also minimize damage to the fastener 110 allowing for re-use of the fastener 110.

In some embodiments, the outer surface 156 of the wall 152 is also designed to be non-abrasive to minimize collateral damage to components that are proximate to the fastener 110, and that come into physical contact with the outer surface 156 while the tool 100 is rotating. In some embodiments, the cavity 126 or the second side 134 of the body 130 can be located so as to stop the downward movement of the tool 100 when the he second side 134 of the body 130 encounters the top side of the fastener 110, preventing damage to the surface 146.

The cutting inserts 121-124 can have a variety of configurations. For example, the cutting inserts 121-124 shown in FIGS. 1 and 2 extend in the first direction 170 partially beyond the non-abrasive face 140 and extend toward the center axis 150 partially beyond the inner surface 154 of the wall 152 of the tool 100.

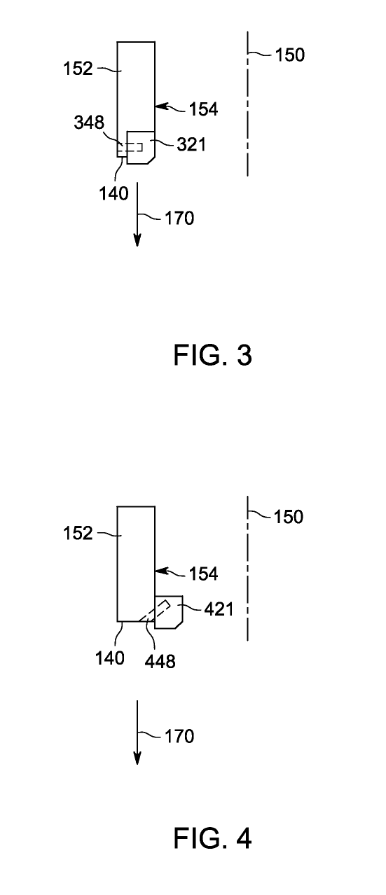

FIG. 3 illustrates a side cross-sectional view of a cutting insert 321 that extends in the first direction 170 partially beyond the non-abrasive face 140 and that does not extend beyond the inner surface 154 of the wall 152 of the tool 100. The cutting insert 321 is flush with the inner surface 154 of the wall 152 of the tool 100. A threaded bolt 348 extends through the wall 152 and is received by the cutting insert 321 to attach to the wall 152. At least a portion of the non-abrasive face 140 remains exposed.

FIG. 4 illustrates a side cross-sectional view of a cutting insert 421 that extends in the first direction 170 partially beyond the non-abrasive face 140 and that extends toward the center axis 150 entirely beyond the inner surface 154 of the wall 152 of the tool 100. A threaded bolt 448 extends through the wall 152 and is received by the cutting insert 421 to attach to the wall 152. At least a portion of the non-abrasive face 140 remains exposed.

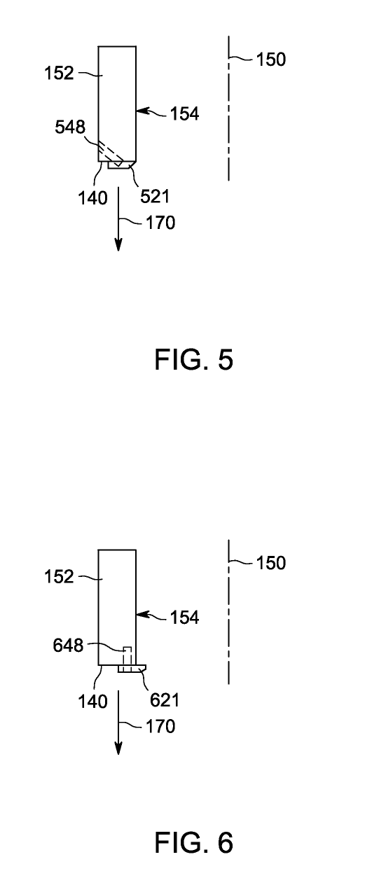

FIG. 5 illustrates a side cross-sectional view of a cutting insert 521 that extends in the first direction 170 entirely beyond the non-abrasive face 140 and that does not extend beyond the inner surface 154 of the wall 152 of the tool 100. A threaded bolt 548 extends through the wall 152 and is received by the cutting insert 521 to attach to the wall 152. At least a portion of the non-abrasive face 140 remains exposed.

FIG. 6 illustrates a side cross-sectional view of a cutting insert 621 that extends in the first direction 170 entirely beyond the non-abrasive face 140 and that partially extends toward the center axis 150 beyond the inner surface 154 of the wall 152 of the tool 100. A threaded bolt 648 extends through the wall 152 and is received by the cutting insert 621 to attach to the wall 152. At least a portion of the non-abrasive face 140 remains exposed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for removing retainer material proximate to a fastener on a surface, the apparatus comprising:
a body comprising a first side and a second side;
a wall extending away from the second side of the body in a first direction, the wall comprising an inner surface, a proximal end, a distal end, and a non-abrasive face at the distal end;
a cavity formed by the second side of the body and the inner surface of the wall, and comprising a center axis extending through the cavity and substantially parallel to the first direction; and
a plurality of cutting inserts disposed proximate to the non-abrasive face and extending in the first direction at least partially beyond the non-abrasive face and wherein at least a portion of the non-abrasive face remains exposed to the surface.

2. The apparatus of claim 1, wherein each of the plurality of cutting inserts extends toward the center axis partially beyond the inner surface of the wall.

3. The apparatus of claim 1, wherein each of the plurality of cutting inserts extends toward the center axis entirely beyond the inner surface of the wall.

4. The apparatus of claim 1, wherein each of the plurality of cutting inserts does not extend beyond the inner surface of the wall.

5. The apparatus of claim 1, wherein each of the plurality of cutting inserts extends in the first direction entirely beyond the non-abrasive face.

6. The apparatus of claim 2, wherein each of the plurality of cutting inserts extends in the first direction entirely beyond the non-abrasive face.

7. The apparatus of claim 1, wherein the wall further comprises an outer surface that is non-abrasive.

8. The apparatus of claim 1, wherein the plurality of cutting inserts form a circumferential cutting path.

9. The apparatus of claim 1, further comprising a shaft attached to the first side of the body and oriented co-axial with the center axis.

10. The apparatus of claim 9, where the shaft is attached to a hand held drilling device.

11. The apparatus of claim 9, where the shaft is attached to a milling machine.

12. The apparatus of claim 1, wherein each of the plurality of cutting inserts includes a chamfer.

13. The apparatus of claim 1, wherein each of the plurality of cutting inserts extend in the first direction at least 0.005 in (0.127 mm) beyond the non-abrasive face.

14. The apparatus of claim 1, wherein the wall forms a cylinder surrounding the cavity.

15. An apparatus for removing retainer material proximate to a fastener on a surface, the apparatus comprising:
a body comprising a first side and a second side;
a wall extending away from the second side of the body in a first direction, the wall comprising an inner surface, a proximal end, a distal end, and a non-abrasive face at the distal end;
a cavity formed by the second side of the body and the inner surface of the wall, and comprising a center axis extending through the cavity and substantially parallel to the first direction;
a shaft attached to the first side of the body and oriented co-axial with the center axis; and
a plurality of cutting inserts disposed proximate to the non-abrasive face and extending in the first direction at least partially beyond the non-abrasive face and wherein at least a portion of the non-abrasive face remains exposed to the surface.

16. The apparatus of claim 15, wherein each of the plurality of cutting inserts extends toward the center axis partially beyond the inner surface of the wall.

17. The apparatus of claim 15, wherein each of the plurality of cutting inserts extends toward the center axis entirely beyond the inner surface of the wall.

18. The apparatus of claim 15, wherein each of the plurality of cutting inserts does not extend beyond the inner surface of the wall.

19. The apparatus of claim 15, wherein each of the plurality of cutting inserts extends in the first direction entirely beyond the non-abrasive face.

20. The apparatus of claim 16, wherein each of the plurality of cutting inserts extends in the first direction entirely beyond the non-abrasive face.
